(19) United States
(12) Patent Application Publication
(10) Pub. No.: US 2016/0323010 A1
(43) Pub. Date: Nov. 3, 2016

(54) METHODS AND APPARATUS FOR MITIGATION OF RADIO-FREQUENCY IMPAIRMENTS IN WIRELESS NETWORK COMMUNICATION

(71) Applicant: Nokia Technologies Oy, Espoo (FI)

(72) Inventors: Peizhi Wu, San Diego, CA (US); Durgaprasad Shamain, San Jose, CA (US)

(73) Assignee: Nokia Technologies Oy

(21) Appl. No.: 14/698,088

(22) Filed: Apr. 28, 2015

(51) Int. Cl. H04B 1/44; H04L 25/02

(52) U.S. Cl. CPC H04B 1/44; H04L 25/0204; H04B 2001/485

(57) ABSTRACT

Systems and techniques for in-phase/quadrature estimation are described. Reference signals are configured and used to perform in-phase and quadrature estimation of a transmitter of a transceiver. Compensation is then performed on the transmitter and the fully-compensated transmitter is used to provide reference signals for in-phase and quadrature estimation of the receiver, and receiver compensation is performed.

### FIELD OF THE INVENTION

The present invention relates generally wireless communication. More particularly, the invention relates to improved systems and techniques for improved mitigation or elimination of radio-frequency impairments in wireless network communication.

### BACKGROUND

Wireless local area networking (often referred to as WLAN or Wifi) applications based on the IEEE 802.11 standard have become increasingly widespread, and serve as an important communications portal. Wireless local area networks may serve home and business users of networks established for a specific group of users and other wireless local area networks users of publicly accessible networks that may be open to all users or through paid or no-cost subscriptions. The number of Wifi users continues to increase and the data needs of such users also continues to increase. Increases in the efficiency and capacity of Wifi networks and devices benefit large numbers of operators and users.

### SUMMARY OF THE INVENTION

In one embodiment of the invention, an apparatus comprises at least one processor and memory storing a program of instructions. The memory storing the program of instructions is configured to, with the at least one processor, cause the apparatus to at least estimate I/Q imbalance for a transmitter of a transceiver based on specified reference signals for transmitter estimation, with reference signals being sequentially received via only the I-branch of the transmitter and only the Q-branch of the receiver; compensate the I/Q imbalance of the transmitter; estimate I/Q imbalance for a receiver of the transceiver based on specified reference signals for receiver estimation with reference signals being received by both the I-branch and Q-branch of the receiver; wherein estimating the I/Q imbalance for the receiver comprises transmitting the receiver reference signals using a transmitter output produced when the I/Q imbalance of the transmitter has been fully compensated; and compensate the I/Q imbalance of the receiver.

In another embodiment of the invention, a method comprises estimating I/Q imbalance for a transmitter of a transceiver based on specified reference signals for transmitter estimation, with reference signals being sequentially received via only the I-branch of the transmitter and only the Q-branch of the receiver; compensating the I/Q imbalance of the transmitter; estimating I/Q imbalance for a receiver of the transceiver based on specified reference signals for receiver estimation with reference signals being received by both the I-branch and Q-branch of the receiver; wherein estimating the I/Q imbalance for the receiver comprises transmitting the receiver reference signals using a transmitter output produced when the I/Q imbalance of the transmitter has been fully compensated; and compensating the I/Q imbalance of the receiver.

In another embodiment of the invention, a non-transitory computer-readable medium stores a program of instructions. Execution of the program of instructions by at least one processor configures an apparatus to at least estimate I/Q imbalance for a transmitter of a transceiver based on specified reference signals for transmitter estimation, with reference signals being sequentially received via only the I-branch of the transmitter and only the Q-branch of the receiver; compensate the I/Q imbalance of the transmitter; estimate I/Q imbalance for a receiver of the transceiver based on specified reference signals for receiver estimation with reference signals being received by both the I-branch and Q-branch of the receiver; wherein estimating the I/Q imbalance for the receiver comprises transmitting the receiver reference signals using a transmitter output produced when the I/Q imbalance of the transmitter has been fully compensated; and compensate the I/Q imbalance of the receiver.

### BRIEF DESCRIPTION OF THE DRAWINGS

FIG. 1 illustrates a receiver according to an embodiment of the present invention;

FIG. 2 illustrates a process of in-phase/quadrature imbalance estimation and compensation according to an embodiment of the present invention;

FIGS. 3-5 illustrate transceiver configurations according to an embodiment of the present invention; and

FIG. 6 illustrates computational elements according to an embodiment of the present invention.

### DETAILED DESCRIPTION

One or more embodiments of the present invention address the mitigation or elimination of radio frequency (RF) impairments in WLAN transmitters or receivers using direct-conversion architecture. A WLAN receiver or transmitter typically consists of an RF front-end implemented in the analog domain and a baseband (BB) implemented in the digital domain. Analog domain implementations are more sensitive to variations in fabrication process technology, supply voltage, and temperature. Such variations (called RF impairments) have detrimental effects on system performance. RF impairments can be mitigated or eliminated using signal processing in the digital baseband domain. Many current consumer-electronics radio transceivers, including those generally used in WLAN, use direct-conversion architecture (DCA). DCA suffers from an RF impairment called in-phase/Quadrature (I/Q) imbalance.

A typical direct down-conversion receiver converts an RF signal to a baseband signal in the analog domain, and a typical direct up-conversion transmitter converts a baseband signal to an RF signal in the analog domain. A baseband signal consists of two quadrature branches—the in-phase (I) and the quadrature (Q) signal.

It is difficult to match the characteristics of analog circuits used between the two quadrature branches. Any mismatch between the in-phase (I) and quadrature-phase (Q) branches manifests as an amplitude and/or phase imbalance. These I/Q imbalances degrade the effective signal-to-interference-and-noise (SINR) ratio by introducing cross-talk (self-noise) between the image subearriers of a typical multi-carrier communication system, such as OFDM. Due to the nature of this impairment, it cannot be mitigated by increasing the transmit power. In addition, the impact of I/Q imbalance is more severe for a system operating at a high SINR region and employing high-order modulation and coding scheme, such as 256-QAM. Therefore, estimation and compensation of I/Q imbalances are crucial for the design and operation of high data-rate wideband systems employing direct-conversion architecture. The I/Q imbalance is present both in a transmitter and a receiver using the direct conversion architecture.

There are two types of I/Q imbalances. An I/Q imbalance that does not vary with the subcarrier frequencies, defined as frequency-independent I/Q imbalance, is generated mostly as a result of the loss of orthogonality and the gain mismatch in the cosine and the sine signals generated in a phase-splitter and used in a mixer (up- or down-converter).

In addition, the analog filters used the I-branches and Q-branches of transceivers have mismatched frequency responses. This introduces an I/Q imbalance that varies with the subcarrier frequencies, and is defined as frequency dependent I/Q imbalance. These filters employ higher order design involving multiple poles and zeros, and thus, have sharp frequency response around the cut-off frequencies. The resulting frequency-selective UQ imbalance more severely affects subcarrier frequencies around the cut-off frequencies.

A transceiver using direct conversion architecture may have I/Q imbalances on both its transmitter and receiver. At the power-on, it does not know the parameters of its own I/Q imbalance since these I/Q imbalances can arise out of variations in fabrication process, supply voltage and ambient temperature, and might have changed since their last measurements.

One or more embodiments of the invention therefore address mechanisms for separately estimating the I/Q imbalances attributable to a transmitter and to a receiver. Embodiments of the invention provide for the use of specimen reference signals and for one or more non-iterative (direct) methods of I/Q imbalance estimation based on these reference signals. Estimations may be performed for a particular transceiver using its transmitter and receiver of a transceiver in a loopback mode.

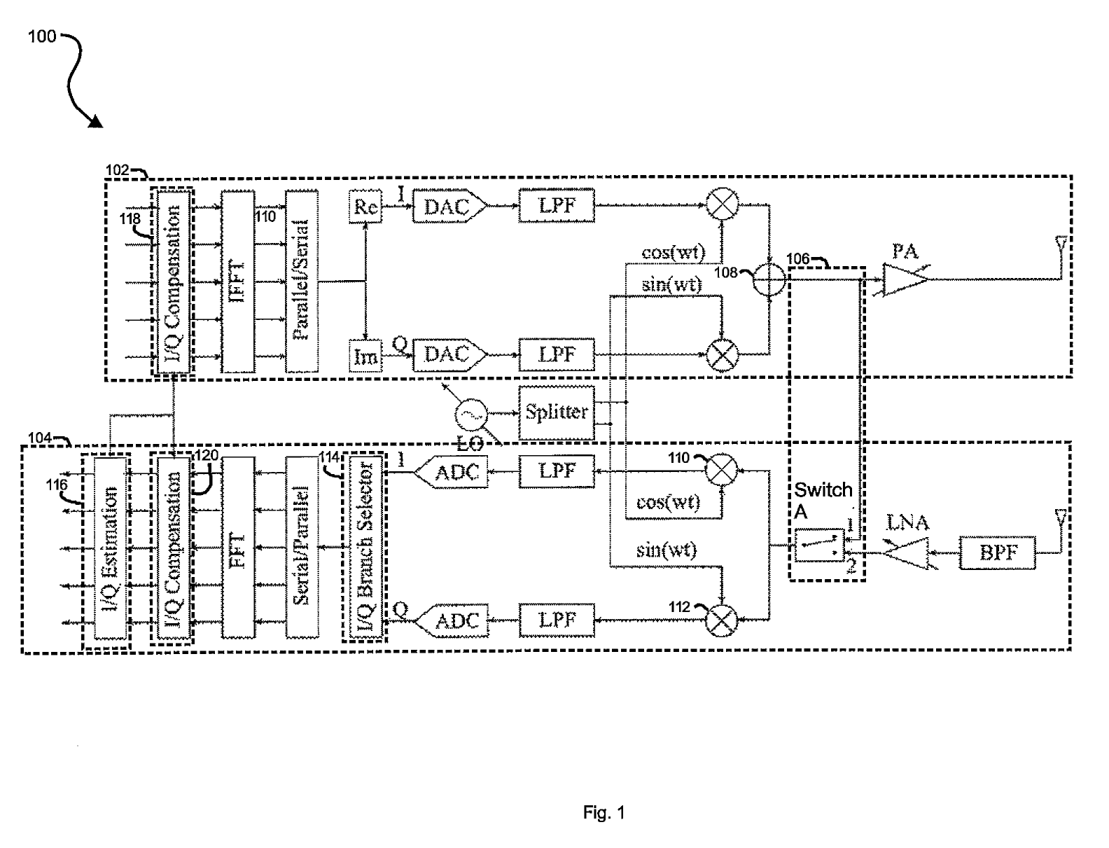

As noted above, embodiments of the present invention provide mechanisms for the design of reference signals and I/Q imbalance estimation using these signals. Estimation may be performed by selection of either the I-branch or the Q-branch at the receiver, combined with use of the internal loopback of the transceiver. FIG. 1 illustrates a transceiver 100 according to an embodiment of the present invention. The transceiver 100 is presented in block diagram form, and comprises transmitter 102 and receiver 104. Of particular interest are elements directed to I/Q estimation. These include an internal loopback element, comprising a 2-position switch 106. The switch 106 may be set to position 1 to activate internal loopback, in which case the output of the summer 108 at the transmitter 102 is connected to the mixers 110 and 112 of the receiver 104. For data transmission, the switch 106 may be set to position 2 to disable external loopback.

The receiver 104 includes an I/Q branch selector 114 and an I/Q imbalances estimation element 116. The I/Q branch selector selects the I- or Q-branch, or both, to form a complex receives signal for baseband processing, and the I/Q imbalances estimation element 116 processes received reference signals at the frequency domain of the receiver, and estimate I/Q balances of the transmitter and receiver.

The transmitter 102 and the receiver 104 include I/Q imbalances compensation elements 118 and 120, respectively. The elements 118 and 120 are controlled by the I/Q imbalances estimation element 116. Compensation may be performed in either the time or the frequency domain, and may be accomplished using any suitable approach.

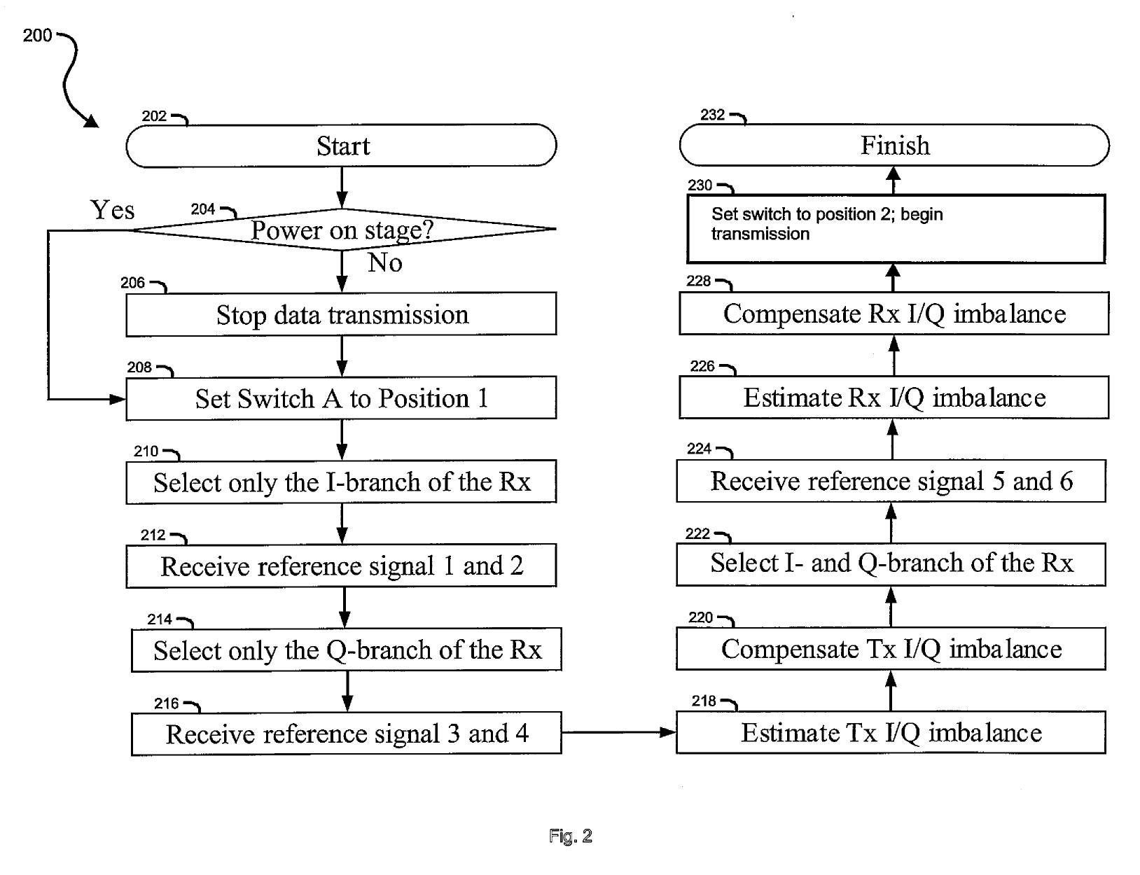

FIG. 2 illustrates a process 200 of I/Q imbalance estimation during the power-on stage of a direct-conversion receiver. The process may be thought of as taking place in two stages—the first stage estimating and compensating the transmitter I/Q imbalance, and the second stage estimating and compensating the receiver I/Q imbalance.

At first, preliminary operations are carried out. The process begins at block 202. At block 204, a determination is made as to whether the transceiver is in a power-on stage. If no, the process proceeds to block 206 and data transmission is stopped. The process then proceeds to block 208. If yes, the process skips to block 208.

The first stage can be thought of as beginning at block 208. At block 208, the switch 106 is set to position 1. At block 210, the 1-branch of the receiver element 104 is selected. At block 212, first and second reference signals are received. At block 214, the Q-branch of the receiver element 104 is selected and at block 216, third and fourth reference signals are received. At block 218, the transmitter I/Q imbalance is estimated and at block 220, the transmitter I/Q imbalance is compensated.

The second stage, transmitter I/Q imbalance estimation and compensation, can be thought of as beginning at block 222. At block 222, both the I- and Q-branch of the receiver are selected. At block 224, reference signals 5 and 6 are received. At block 226, receiver I/Q imbalance is estimated and at block 228, receiver I/Q imbalance is compensated. At block 230, the switch is set to position 1 and transmission begins. The process then terminates at block 232.

The estimation process can estimate the transmitter's impairments despite receiver impairments. The I/Q compensation elements at the transmitter and the receiver can be internally bypassed. The input of mixers of the receiver are selected from the output of the phase splitter at the transmitter.

Denote by γ_{T} the magnitude of the cosine wave, φ_{T} the phase error of the LO signals, and w_{c} the central angular frequency for up-conversion. Then the output of phase splitter is u_{T}(t)=cos w_{c}t−jγ_{T} sin(w_{c}t−φ_{T}).

Let the frequency response of the low-pass filter on the transmitter's I- and Q-branch be G_{I}^{T}[k] and G_{Q}^{T}[k], respectively. The LPFs have real impulse response, so G_{I}^{T}[k]=G_{I}^{T}*[−k] and G_{Q}^{T}[k]=G_{Q}^{T}*[−k], where (•)* refers to the conjugate of a complex number.

Denote by S[k] and S[−k] the modulated data symbol in subcarrier k and −k, respectively. In the presence of I/Q imbalance, the baseband equivalent transmitter data symbol at the radio front end \tilde{S}[k] is given by

$$\tilde{S} [ k ] = \frac{{G}_{T}^{I} [ k ] + {γ}_{T} {e}^{j {φ}_{T}} {G}_{T}^{Q} [ k ]}{2} S [ k ] + \frac{{G}_{T}^{I} [ k ] - {γ}_{T} {e}^{j {φ}_{T}} {G}_{T}^{Q} [ k ]}{2} {S}^{*} [ - k ] .$$

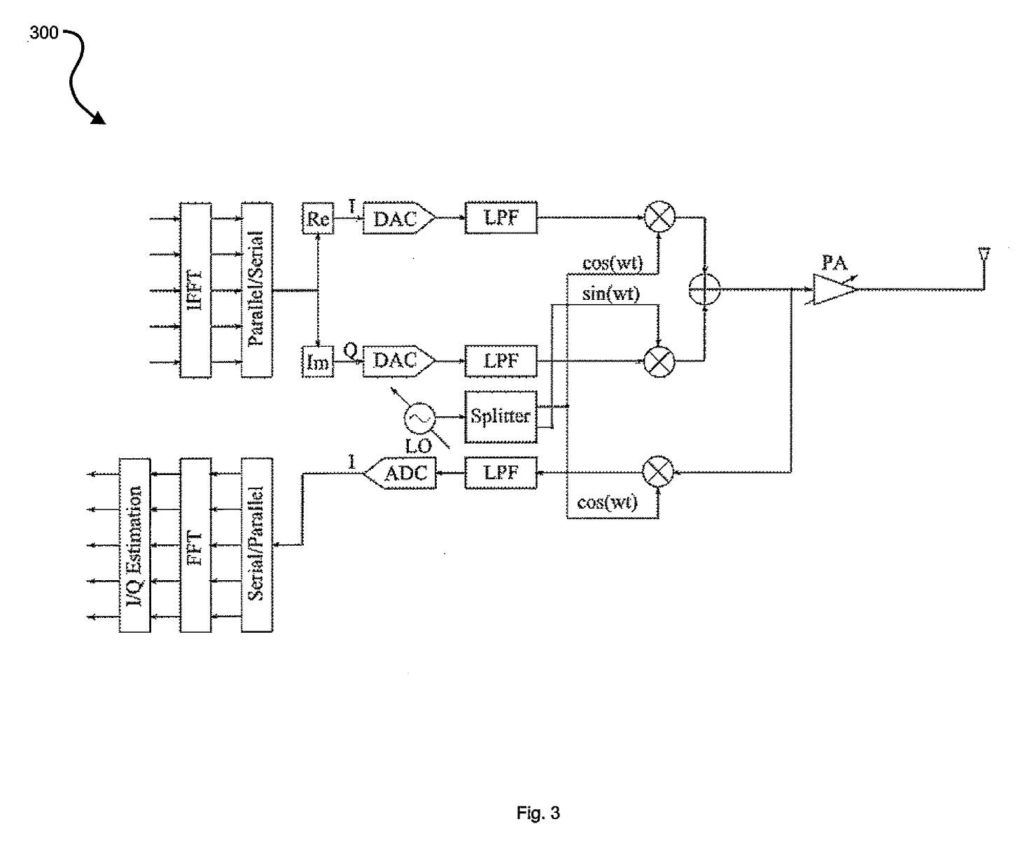

In an example, the transceiver 100 selects the Q-branch of the receiver 104. The received signal is thus received only by the I-branch. The effective signal path is illustrated by the configuration 300 shown in FIG. 3.

The received symbol on subcarrier k at the output of the fast Fourier transform block is given by

$${X}^{I} [ k ] = {G}_{R}^{I} [ k ] \frac{\tilde{S} [ k ] + {\tilde{S}}^{*} [ - k ]}{2} + {N}^{I} [ k ]$$

where N^{I}[k] is the noise term.

The following two reference signals may be designed as follows, and are suitably transmitted in two disjoint time intervals:

1. Reference signal 1: S₁[k]=1 and S₁[−k]=1. The corresponding received signal on subcarrier k is given by

X₊^{I}[k]=G_{R}^{I}[k]G_{T}^{I}[k]+N₊^{I}[k]

2. Reference signal 2: S₂[k]=−j and S₂[−k]=−j. The corresponding received signal on subcarrier k is given by

X₋^{I}[k]=G_{R}^{I}[k]G_{T}^{I}[k] sin φ_{T}γ_{T}+N₋^{I}[k]

where N₊^{I}[k] and N₋^{I}[k] are the noise terms.

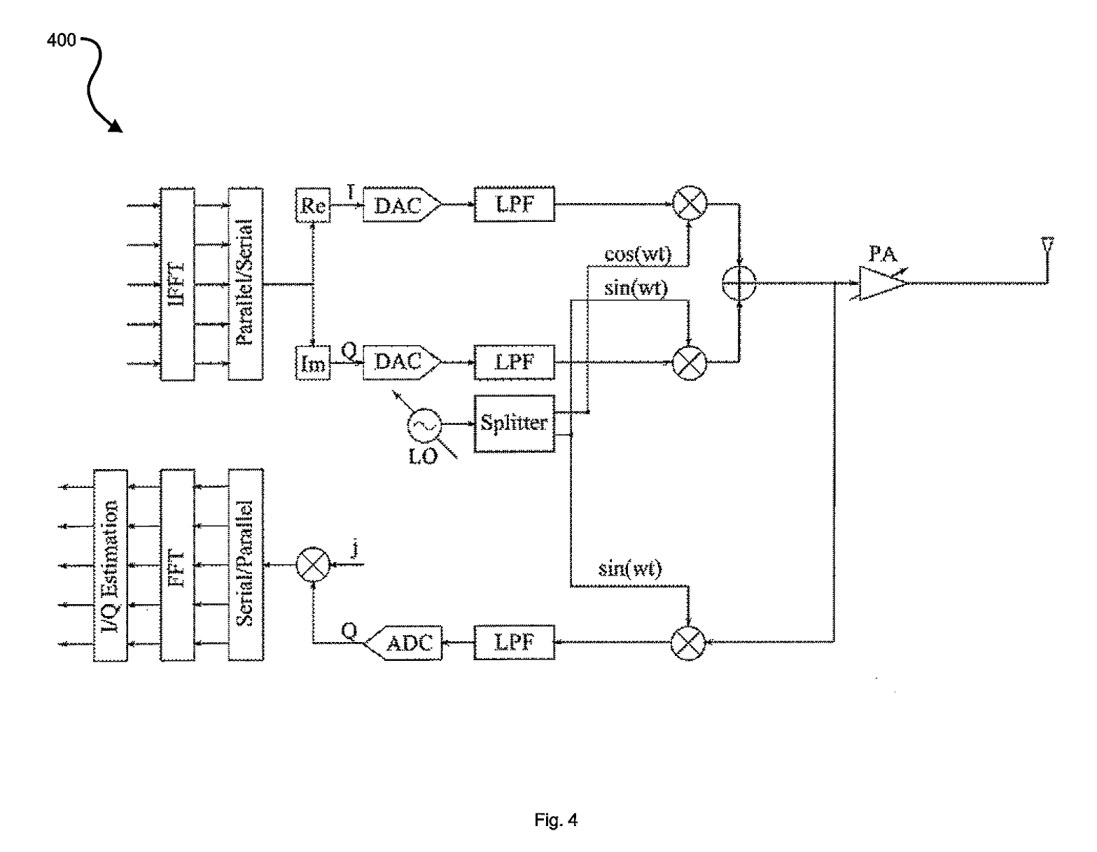

Next, operations are performed with the reference signals being received only by the Q-branch of the receiver. The transceiver 100 deselects the I-branch of the receiver 104 so that the received signal is received only by the Q-branch. The effective signal path is shown by the configuration 400 of FIG. 4.

Since the sine and cosine waves for down-conversion come from the transmitter, the received symbol on subcarrier k is given by

$${X}^{Q} [ k ] = {γ}_{R} {G}_{R}^{Q} [ k ] \frac{{e}^{- j {φ}_{T}} \tilde{S} [ k ] - {e}^{j {φ}_{T}} {\tilde{S}}^{*} [ - k ]}{2} + {N}^{Q} [ k ]$$

where N^{Q}[k] is the noise term.
The following two reference signals are designed as follows and are transmitted in two disjoint time intervals:

1. Reference signal 3: S₃[k]=j and S₃[−k]=−j. The corresponding received symbol on subcarrier k is given by

X₊^{Q}[k]=γ_{R}G_{R}^{Q}[k]G_{T}^{I}[k] sin φ_{T}+N₊^{Q}[k]

2. Reference signal 4: S₄[k]=1 and S₄[−k]=−1. The corresponding received symbol on subcarrier k is given by

X₋^{Q}[k]=γ_{R}G_{R}^{Q}[k]G_{T}^{I}[k]γ_{T}+N₋^{Q}[k]

where N₊^{Q}[k] and N₋^{Q}[k] are the noise terms.

The estimation can be a least squares estimation.

Let

$${β}_{T} [ k ] {=}^{Δ} {γ}_{T} \vert \frac{{G}_{T}^{Q} [ k ]}{{G}_{T}^{I} [ k ]} \vert , {θ}_{T} [ k ] {=}^{Δ} arg ( \frac{{G}_{T}^{Q} [ k ]}{{G}_{T}^{I} [ k ]} )$$

$$X {=}^{Δ} {[ {X}_{+}^{I} [ k ] , {X}_{-}^{I} [ k ] , {X}_{+}^{Q} [ k ] , {X}_{-}^{Q} [ k ] ]}^{T} . \\ G {=}^{Δ} {[ {G}_{R}^{I} [ k ] {G}_{T}^{I} [ k ] , {γ}_{R} {G}_{R}^{Q} [ k ] {G}_{T}^{I} [ k ] ]}^{T}$$

$$A {=}^{Δ} {[ \begin{matrix}1 & {β}_{T} [ k ] {e}^{j {θ}_{T} [ k ]} sin {φ}_{T} & 0 & 0 \\ 0 & 0 & sin {φ}_{T} & {β}_{T} [ k ] {e}^{j {θ}_{T} [ k ]}\end{matrix} ]}^{T} ,$$

where [ ]^{T} refers to the transpose of a matrix. The least squares estimator is found by solving the following optimization problem:

$$arg {min}_{{β}_{T} [ k ] , {θ}_{T} [ k ] , {φ}_{T}} \vert \vert X - AG {\vert \vert}^{2} , subject to G ∈ {C}^{( 2 )}$$

The optimal estimation of G, denoted by Ĝ, can be found by quadratic minimization A^{H}X=A^{H}AĜ, where (•)^{H} refers to the conjugate transpose of a complex matrix. Therefore, after substituting Ĝ in the optimization problem, the variables are β_{T}[k], φ_{T} and θ_{T}[k].

Because reference signal goes through the internal loopback instead of the channel, the signal-to-noise ratio can be very high. At this high signal-to-noise ratio region, the estimation of \hat{β}_{T}[k] and \hat{φ}_{T}[k] can be approximated as follows:

$${\hat{β}}_{T} [ k ] \approx \sqrt{\vert \frac{{X}_{-}^{Q} [ k ] {X}_{-}^{I *} [ k ]}{{X}_{+}^{Q} [ k ] {X}_{+}^{I *} [ k ]} \vert}$$

$${\hat{φ}}_{T} [ k ] = \pm arcsin \sqrt{\vert \frac{{X}_{+}^{Q} [ k ] {X}_{-}^{I *} [ k ]}{{X}_{-}^{Q} [ k ] {X}_{+}^{I *} [ k ]} \vert}$$

The least squares estimator of \tilde{θ}_{T}[k] can be determined as

$${\hat{θ}}_{T} [ k ] = - sgn {\hat{φ}}_{T} [ k ] arg [ \frac{{X}_{+}^{I} [ k ] {X}_{-}^{I *} [ k ]}{1 + {\hat{β}}_{T}^{2} [ k ] {sin}^{2} {\hat{φ}}_{T} [ k ]} + \frac{{X}_{+}^{Q} [ k ] {X}_{-}^{Q *} [ k ]}{{\hat{β}}_{T}^{2} [ k ] + {sin}^{2} {\hat{φ}}_{T} [ k ]} ]$$

Then an estimation of LO signal phase mismatch \hat{φ}_{T} can be found by averaging across all subcarriers:

$${\hat{φ}}_{T} = {mean}_{k} {\hat{φ}}_{T} [ k ]$$

Once the I/Q transmitter imbalance has been estimated, the estimates can be used to compensate the I/Q imbalance. Compensation may be performed in the frequency domain or the time domain at the baseband of the transmitter.

The receiver I/Q imbalance is then estimated. The compensated transmitter can be used to estimate I/Q imbalance of the receiver. By this point, the I/Q imbalance of the transmitter is completely compensated, so the composite transfer function of the transmitter's Q-branch is substantially (or exactly) the same as the I-branch. Therefore, the lowpass equivalent of the transmitter symbol is given by

\tilde{S}[k]=G_{T}^{I}[k]S[k].

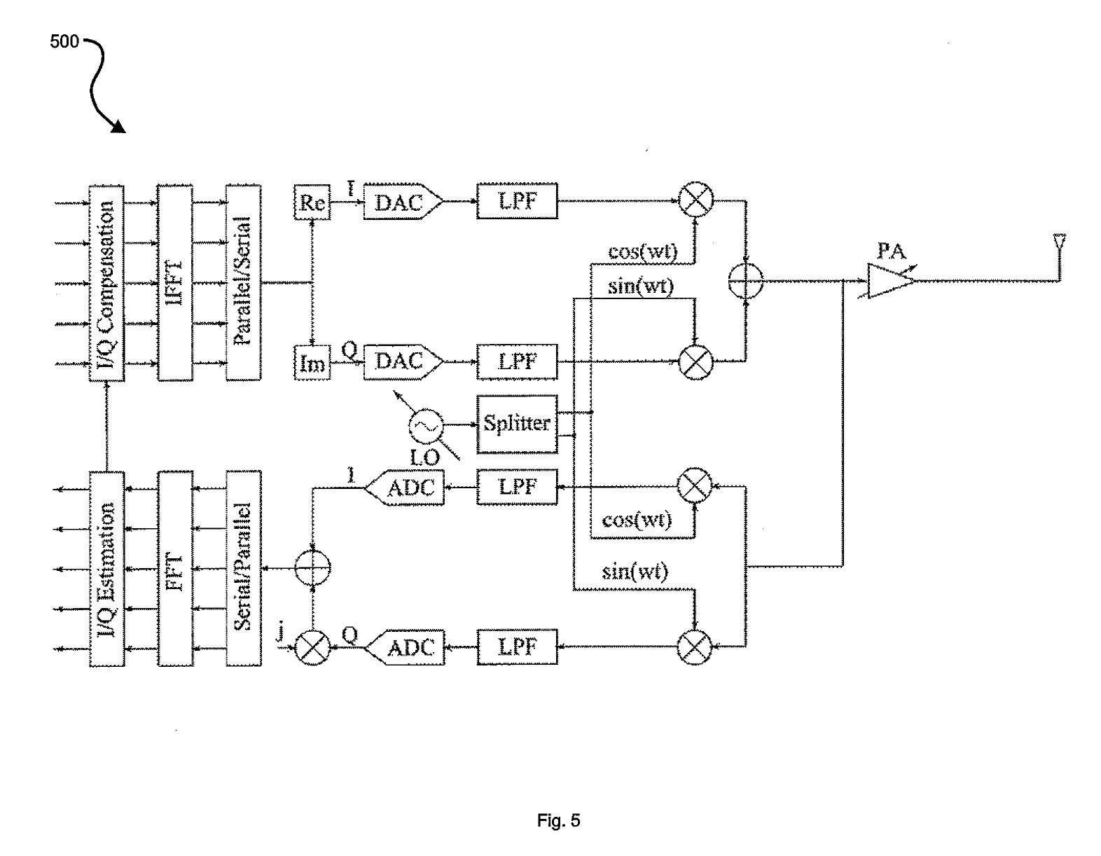

The I/Q compensation block at the receiver 104 can be internally bypassed. The input of the mixers of the receiver can be selected from the output of the phase splitter at the transmitter. The effective signal path is shown by the configuration 500 of FIG. 5.

The magnitude of the cosine wave is denoted by γ_{R}, the phase error of the phase splitter by φ_{R}, and the central angular frequency for down-conversion by w_{c}. Then the output of phase splitter at the receiver is given by u_{R}(t)=cos w_{c}t+jγ_{R} sin(w_{c}t−φ_{R}).

Suppose that the frequency response of the lowpass filter on the transmitter's I- and Q-branch be G_{I}^{R}[k] and G_{Q}^{R}[k], respectively. The LPFs have real impulse response, so G_{I}^{R}[k]=G_{I}^{R}*[−k] and G_{Q}^{R}[k]=G_{Q}^{R}*[−k], where (•)* refers to the conjugate of a complex number. Define

$${β}_{R} [ k ] {-}^{Δ} {γ}_{R} \vert \frac{{G}_{R}^{Q} [ k ]}{{G}_{R}^{I} [ k ]} \vert , {θ}_{R} [ k ] {-}^{Δ} arg ( \frac{{G}_{R}^{Q} [ k ]}{{G}_{R}^{I} [ k ]} ) .$$

Reference signals may be designed as follows, and transmitted in two disjoint time intervals:

Reference signal 5: S₅[k]=1 and S₅[−k]=0. The corresponding received symbols on subcarrier k and −k at the output of the fast Fourier transform block are given by

$${X}_{+} [ k ] = {G}_{R}^{I} [ k ] {G}_{T}^{I} [ k ] \frac{1 + {β}_{R} [ k ] {e}^{j ( {θ}_{R} [ k ] - {φ}_{R} )}}{2} + {N}_{+} [ k ]$$

$${X}_{+}^{*} [ - k ] = {G}_{R}^{I} [ k ] {G}_{T}^{I} [ k ] \frac{1 - {β}_{R} [ k ] {e}^{j ( {θ}_{R} [ k ] - {φ}_{R} )}}{2} + {N}_{+}^{*} [ - k ]$$

Reference signal 6: S₆[k]=0 and S₆[−k]=1. The corresponding received symbols on subcarrier k and −k at the output of the fast Fourier transform block are given by

$${X}_{-} [ k ] = {G}_{R}^{I} [ k ] {G}_{T}^{I} [ k ] \frac{1 - {β}_{R} [ k ] {e}^{j ( {θ}_{R} [ k ] + {φ}_{R} )}}{2} + {N}_{-} [ k ]$$

$${X}_{-}^{*} [ - k ] = {G}_{R}^{I} [ k ] {G}_{T}^{I} [ k ] \frac{1 + {β}_{R} [ k ] {e}^{j ( {θ}_{R} [ k ] + {φ}_{R} )}}{2} + {N}_{-}^{*} [ - k ]$$

where N₊[k] and N₋[k] are the noise terms.

I/Q imbalance estimation for the receiver is then performed. The estimation method may, for example, be least squares estimation, given by

$${\hat{β}}_{R} [ k ] = \frac{\vert {X}_{+} [ k ] - {X}_{+}^{*} [ - k ] \vert + \vert {X}_{-} [ k ] - {X}_{-}^{*} [ - k ] \vert}{\vert {X}_{+} [ k ] + {X}_{+}^{*} [ - k ] + {X}_{-} [ k ] + {X}_{-}^{*} [ k - ] \vert}$$

$${\hat{θ}}_{R} = \frac{arg ( {X}_{+} [ k ] - {X}_{+}^{*} [ - k ] ) - arg ( {X}_{-} [ k ] - {X}_{-}^{*} [ - k ] )}{2} - arg ( {X}_{+} [ k ] + {X}_{+}^{*} [ - k ] + {X}_{-} [ k ] + {X}_{-}^{*} [ - k ] )$$

$${\hat{φ}}_{R} = - \frac{1}{N} {\sum }_{k = - N \text{/} 2}^{N \text{/} 2} \frac{arg ( {X}_{+} [ k ] - {X}_{+}^{*} [ - k ] ) + arg ( {X}_{-} [ k ] - {X}_{-}^{*} [ - k ] )}{2}$$

I/Q imbalance of the receiver may then be compensated in the frequency domain or the time domain at the digital baseband of the receiver.

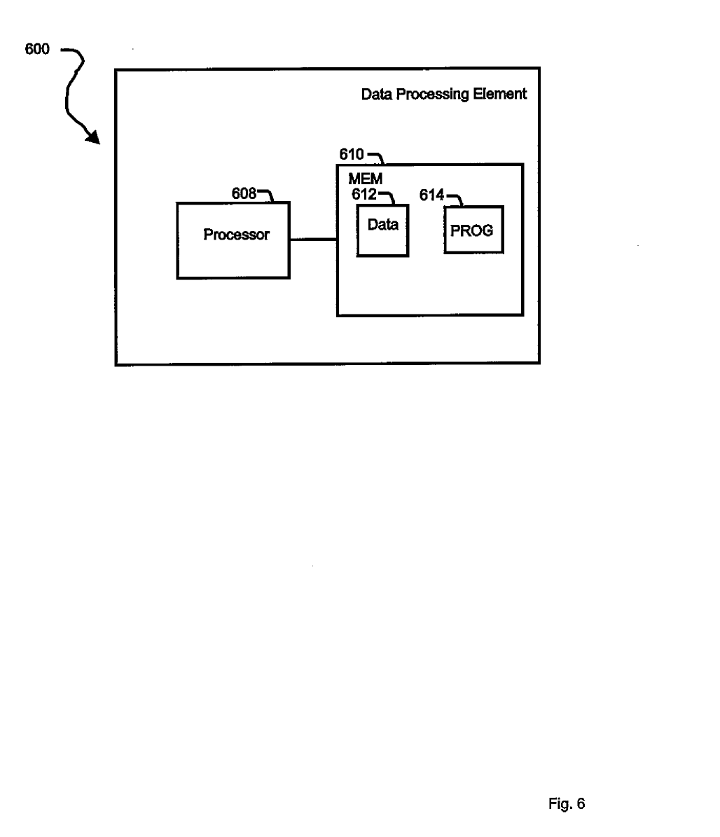

FIG. 6 presents a data processing element 600 that may be used in a transceiver such as the transceiver 100 to perform I/Q imbalance estimation and compensation. Multiple data processing elements such as the element 600 may be employed, or a single element may independently serve different components of the transceiver 100, such as the transmitter 102 or the receiver 104.

The data processing element 600 may include a processor 608 and memory 610. The data processing element 600 may employ data 612 and programs (PROGS) 614, residing in memory 610.

At least one of the PROGs 614 in the data processing element 600 is assumed to include a set of program instructions that, when executed by the associated processor 608, enable the data processing element to operate in accordance with embodiments of this invention. In these regards, embodiments of this invention may be implemented at least in part by computer software stored on the MEM 610, which is executable by the processor 608 of the data processing element 600, or by hardware, or by a combination of tangibly stored software and hardware (and tangibly stored firmware). Electronic devices implementing these aspects of the invention need not be the entire devices as depicted at FIG. 1 or FIG. 6 or may be one or more components of same such as the above described tangibly stored software, hardware, firmware and processor, or a system on a chip SOC or an application specific integrated circuit ASIC.

Various embodiments of the computer readable MEM 610 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 408 include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While various exemplary embodiments have been described above it should be appreciated that the practice of the invention is not limited to the exemplary embodiments shown and discussed here.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

Various modifications and adaptations to the foregoing exemplary embodiments of this invention may become apparent to those skilled in the relevant arts in view of the foregoing description. While various exemplary embodiments have been described above it should be appreciated that the practice of the invention is not limited to the exemplary embodiments shown and discussed here.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising:
at least one processor;
memory storing a program of instructions;
wherein the memory storing the program of instructions is configured to, with the at least one processor, cause the apparatus to at least:
estimate in-phase/quadrature (I/Q) imbalance for a transmitter of a transceiver based on specified reference signals for transmitter estimation, with reference signals being sequentially received via only the I-branch of the receiver and only the Q-branch of the receiver;
compensate the I/Q imbalance of the transmitter;
estimate I/Q imbalance for a receiver of the transceiver based on specified reference signals for receiver estimation with reference signals being received by both the I-branch and Q-branch of the receiver;
wherein estimating the I/Q imbalance for the receiver comprises transmitting the receiver reference signals using a transmitter output produced when the I/Q imbalance of the transmitter has been fully compensated; and
compensating the I/Q imbalance of the receiver.

2. The apparatus of claim 1, wherein estimating I/Q imbalance of the transmitter comprises receiving a first set of reference signals at the I-branch of the receiver and a second set of reference signals at the Q-branch of the receiver, and wherein estimating I/Q imbalance of the receiver comprises receiving a third set of reference signals at both the I- and Q-branches of the receiver.

3. The apparatus of claim 1, wherein the transceiver is configured to enable internal loopback for I/Q imbalance estimation, and to disable internal loopback for data communication.

4. The apparatus of claim 1, wherein each set of reference signals is a pair of reference signals, and wherein the reference signals of a pair are transmitted in two disjoint time intervals.

5. The apparatus of claim 1, wherein I/Q imbalance estimation is least squares estimation.

6. A method comprising:
estimating in-phase/quadrature (I/Q) imbalance for a transmitter of a transceiver based on specified reference signals for transmitter estimation, with reference signals being sequentially received via only the I-branch of the receiver and only the Q-branch of the receiver;
compensating the I/Q imbalance of the transmitter;
estimating I/Q imbalance for a receiver of the transceiver based on specified reference signals for receiver estimation with reference signals being received by both the I-branch and Q-branch of the receiver;
wherein estimating the I/Q imbalance for the receiver comprises transmitting the receiver reference signals using a transmitter output produced when the I/Q imbalance of the transmitter has been fully compensated; and
compensating the I/Q imbalance of the receiver.

7. The method of claim 6, wherein estimating I/Q imbalance of the transmitter comprises receiving a first set of reference signals at the I-branch of the receiver and a second set of reference signals at the Q-branch of the receiver, and wherein estimating I/Q imbalance of the receiver comprises receiving a third set of reference signals at both the I- and Q-branches of the receiver.

8. The method of claim 6, wherein the transceiver is configured to enable internal loopback for I/Q imbalance estimation, and to disable internal loopback for data communication.

9. The method of claim 6, wherein each set of reference signals is a pair of reference signals, and wherein the reference signals of a pair are transmitted in two disjoint time intervals.

10. The method of claim 6, wherein I/Q imbalance estimation is least squares estimation.

11. A non-transitory computer-readable medium storing a program of instructions execution of which by at least one processor configures an apparatus to at least:
estimate in-phase/quadrature (I/Q) imbalance for a transmitter of a transceiver based on specified reference signals for transmitter estimation, with reference signals being sequentially received via only the I-branch of the receiver and only the Q-branch of the receiver;
compensate the I/Q imbalance of the transmitter;
estimate I/Q imbalance for a receiver of the transceiver based on specified reference signals for receiver estimation with reference signals being received by both the I-branch and Q-branch of the receiver;
wherein estimating the I/Q imbalance for the receiver comprises transmitting the receiver reference signals using a transmitter output produced when the I/Q imbalance of the transmitter has been fully compensated; and
compensating the UQ imbalance of the receiver.

12. The non-transitory computer-readable medium of claim 11, wherein estimating I/Q imbalance of the transmitter comprises receiving a first set of reference signals at the I-branch of the receiver and a second set of reference signals at the Q-branch of the receiver, and wherein estimating I/Q imbalance of the receiver comprises receiving a third set of reference signals at both the I- and Q-branches of the receiver.

13. The non-transitory computer-readable medium of claim 11, wherein the transceiver is configured to enable internal loopback for IQ imbalance estimation, and to disable internal loopback for data communication.

14. The non-transitory computer-readable medium of claim 11, wherein each set of reference signals is a pair of reference signals, and wherein the reference signals of a pair are transmitted in two disjoint time intervals.

15. The non-transitory computer-readable medium of claim 11, wherein I/Q imbalance estimation is least squares estimation.
